(19) United States
(12) Patent Application Publication
(10) Pub. No.: US 2019/0341826 A1
(43) Pub. Date: Nov. 7, 2019

(54) ELECTRIC POWERHEAD

(71) Applicant: BRIGGS & STRATTON CORPORATION, Wauwatosa, WI (US)

(72) Inventors: Jeffrey M. Zeiler, Wauwatosa, WI (US); David Schulenberg, Kewaskum, WI (US); Michael Meyer, Sussex, WI (US); Timothy Christen, Wauwatosa, WI (US); Christy Matuszewski, Oak Creek, WI (US); Jim Nommensen, Oak Creek, WI (US)

(73) Assignee: BRIGGS & STRATTON CORPORATION, Wauwatosa, WI (US)

(21) Appl. No.: 16/344,787

(22) PCT Filed: Oct. 26, 2017
(86) PCT No.: PCT/US17/58492

§ 371 Date: Apr. 24, 2019

Related U.S. Application Data
(60) Provisional application No. 62/413,802, filed on Oct. 27, 2016.

(51) Int. Cl. H02K 7/00; H02K 11/00; H02K 5/20; F16D 3/06; B05B 15/00

(52) U.S. Cl. CPC H02K 7/003; H02K 11/0094; H02K 5/20; A01D 34/6806; B05B 15/00; H02K 2205/09; F16D 3/06

(57) ABSTRACT

An electric powerhead includes a housing including a mounting plate, wherein the mounting plate includes a shaft opening, multiple first openings arranged in a standard vertical shaft engine mounting pattern and multiple second openings arranged in a standard horizontal shaft engine mounting pattern, an electric motor positioned within the housing, wherein the electric motor includes an output shaft that extends through the shaft opening of the mounting plate and wherein the output shaft is configured to rotate about an axis of rotation, and a support configured to be removably attached to the housing, wherein with the support attached to the housing, the output shaft is arranged horizontally.

### CROSS-REFERENCE TO RELATED APPLICATIONS

This application claims the benefit of U.S. Provisional Application No. 62/413,802, filed Oct. 27, 2016, which is incorporated herein by reference in its entirety.

### BACKGROUND

The present invention generally relates to prime movers for outdoor power equipment. More specifically, the present invention relates to an electric power head and energy storage device for driving and/or powering various components of a piece of outdoor power equipment.

### SUMMARY

One embodiment of the invention includes an electric powerhead. The electric powerhead includes a housing including a mounting plate including a shaft opening, a plurality of first openings arranged in a standard vertical shaft engine mounting pattern, a plurality of second openings arranged in a standard horizontal shaft engine mounting pattern, an electric motor positioned within the housing, and a support configured to be removably attached to the housing. The electric motor includes an output shaft that extends through the shaft opening of the mounting plate and the output shaft is configured to rotate about an axis of rotation. The support is attached to the housing and the output shaft is arranged horizontally.

Another embodiment of the invention includes an electric powerhead. The electric powerhead includes a housing including a mounting plate including a shaft opening, an electric motor positioned within the housing, and a support configured to be removably attached to the housing. The electric motor includes an output shaft that extends through the shaft opening of the mounting plate and the output shaft is configured to rotate about an axis of rotation. The support includes a plurality of openings arranged in a horizontal shaft supporting pattern.

Another embodiment of the invention includes an electric powerhead. The electric powerhead includes a housing including a mounting plate including a shaft opening, a battery receptacle, an electric motor positioned within the housing, and a battery configured to be removably attached to the battery receptacle to provide electricity to the electric motor. The electric motor includes an output shaft that extends through the shaft opening of the mounting plate and wherein the output shaft is configured to rotate about an axis of rotation. The battery receptacle is positioned so that a straight axis of insertion along which the battery is inserted into the receptacle is positioned at an angle relative to the axis of rotation of the output shaft.

Another embodiment of the invention includes an electric powerhead. The electric powerhead includes a housing including a mounting plate including a shaft opening, an electric motor positioned within the housing, and a support configured to be removably attached to the housing. The electric motor includes an output shaft that extends through the shaft opening of the mounting plate and the output shaft is configured to rotate about an axis of rotation. With the support attached to the housing, a bottom surface of the support is spaced apart from the axis of rotation of the output shaft by a vertical distance equal to a standard horizontal shaft engine spacing.

Another embodiment of the invention includes an electric powerhead. The electric powerhead includes a housing including a mounting plate including a shaft opening, an electric motor positioned within the housing, where the electric motor includes an output shaft that extends through the shaft opening of the mounting plate and the output shaft is configured to rotate about an axis of rotation. The output shaft includes a first coupling. The electric powerhead further includes a power take off including a second coupling configured to removably attach to the first coupling of the output shaft. In some embodiments, the first coupling comprises an internal spline and the second coupling comprises an external spline.

Another embodiment of the invention includes an electric powerhead. The electric powerhead includes a housing including a mounting plate including a shaft opening, a battery receptacle, an electric motor positioned within the housing, and a battery configured to be removably attached to the battery receptacle to provide electricity to the electric motor. The electric motor includes an output shaft that extends through the shaft opening of the mounting plate and wherein the output shaft is configured to rotate about an axis of rotation. The battery receptacle is positioned so that a straight axis of insertion along which the battery is inserted into the receptacle is positioned at an angle relative to the axis of rotation of the output shaft. In some embodiments, the battery receptacle includes a stop surface that is configured to contact a face of the battery when the battery is inserted into the receptacle and the stop surface is positioned at an angle relative to the axis of rotation of the output shaft.

Another embodiment of the invention includes an electric powerhead. The electric powerhead includes a motor housing including a mounting plate and a battery receptacle housing rotatably attached to the motor housing about a housing axis of rotation. The mounting plate includes a shaft opening and the battery receptacle housing includes a battery receptacle. The electric powerhead further includes an electric motor positioned within the motor housing and a battery configured to removably attached to the battery receptacle to provide electricity to the electric motor. The electric motor includes an output shaft that extends through the shaft opening of the mounting plate and the output shaft is configured to rotate about a shaft axis of rotation. In some embodiments, the housing axis of rotation is positioned at an angle to the shaft axis of rotation. In some embodiments, the housing axis of rotation is parallel to the shaft axis of rotation. In some embodiments, the housing axis of rotation and the shaft axis of rotation are collinear. In some embodiments, the housing axis of rotation and the shaft axis of rotation are not collinear.

Another embodiment of the invention includes an electric powerhead. The electric power head includes an electric motor including an output shaft that is configured to rotate about an axis of rotation, a battery receptacle including receptacle contacts, and a battery configured to be removably attached to the battery receptacle. The battery includes battery contacts configured to engage the receptacle contacts when the battery is attached to the battery receptacle to complete an electrical circuit. The electric powerhead includes a controller electrically coupled to the receptacle contacts and to the electric motor, and an accessory interface electrically coupled to the controller. The controller is configured to control operation of the electric motor. The accessory interface is configured to electrically couple the controller to an accessory. In some embodiments, the accessory interface is configured to provide electricity from the battery to the accessory. In some embodiments, the accessory interface is configured to provide data communication between the controller and the accessory.

Another embodiment of the invention includes an electric powerhead. The electric powerhead includes a housing including an intake vent, an exhaust vent, and a mounting plate. The mounting plate includes a shaft opening and an outer surface. The electric powerhead includes an electric motor positioned within the housing. The electric motor includes a stator, a rotor, and an output shaft, where the rotor and the output shaft are configured to rotate about an axis of rotation, and the output shaft extends through the shaft opening of the mounting plate with an end of the output shaft positioned outside of the housing so the outer surface of the mounting plate is positioned between the end of the output shaft and the stator. During operation, air is drawn into the housing through the intake vent, passes over the electric motor, and exits the housing through the exhaust vent. The outer surface of the mounting plate is positioned between the end of the output shaft and the intake vent. The outer surface of the mounting plate is positioned between the end of the output shaft and the exhaust vent.

Another embodiment of the invention includes an electric powerhead. The electric powerhead includes a housing including a housing battery receptacle and an electric motor positioned within the housing. The electric motor includes an output shaft that is configured to rotate about an axis of rotation. The electric powerhead further includes a battery tray including a plurality of tray battery receptacles and a plug electrically coupled to the tray battery receptacles and a plurality of batteries. The plug is configured to be removably attached to the housing battery receptacle to complete an electrical circuit between the tray battery receptacles and the housing battery receptacle. Each battery is configured to be removably attached to either the housing battery receptacle or one of the tray battery receptacle to complete an electrical circuit between the battery and the receptacle the battery is attached to. In some embodiments, the battery tray is spaced apart from the housing.

### BRIEF DESCRIPTION OF THE DRAWINGS

The invention will become more fully understood from the following detailed description, taken in conjunction with the accompanying drawings, in which:

FIG. 1 is a perspective view on an electric powerhead, according to an exemplary embodiment, with the electric powerhead in a vertical shaft orientation;

FIG. 2 is a perspective view of the electric powerhead of FIG. 1 in a horizontal shaft orientation;

FIG. 3 is a perspective view of an accessory interface with a cover attached;

FIG. 4 is a front view of the cover of FIG. 3;

FIG. 5 is a front view of a mounting plate of the electric powerhead of FIG. 1, according to an exemplary embodiment;

FIG. 6 is a side view of a removable support of the electric powerhead of FIG. 1, according to an exemplary embodiment;

FIG. 7 is a bottom view of the removable support of FIG. 4;

FIG. 8 is a perspective view of an electric powerhead, according to an exemplary embodiment, with the electric powerhead in a vertical shaft orientation;

FIG. 9 is a perspective view of the electric powerhead of FIG. 6 in a horizontal shaft orientation;

FIG. 10 is a perspective view of a walk behind lawn mower, according to an exemplary embodiment;

FIG. 11 is a schematic view of a portion of the lawn mower of FIG. 10;

FIG. 12 is a schematic view of a portion of the lawn mower of FIG. 10;

FIG. 13 is a schematic view of a mower deck for a wide area walk behind lawn mower, according to an exemplary embodiment;

FIG. 14 is a perspective view of an electric powerhead including a removable power takeoff, according to an exemplary embodiment, with the electric powerhead in a horizontal shaft orientation;

FIG. 15 is a perspective view of the electric powerhead of FIG. 14;

FIG. 16 is a perspective view of a snow thrower, according to an exemplary embodiment;

FIG. 17 is a schematic view of a portion of the snow thrower of FIG. 16;

FIG. 18 is a schematic view of a portion of the snow thrower of FIG. 16;

FIG. 19 is a schematic view of a paint sprayer, according to an exemplary embodiment;

FIG. 20 is a perspective view of an electric powerhead including a battery tray, according to an exemplary embodiment, with the electric powerhead in a horizontal shaft orientation; and

FIG. 21 is a perspective view of the battery tray of FIG. 20.

### DETAILED DESCRIPTION

Before turning to the figures, which illustrate the exemplary embodiments in detail, it should be understood that the application is not limited to the details or methodology set forth in the description or illustrated in the figures. It should also be understood that the terminology is for the purpose of description only and should not be regarded as limiting.

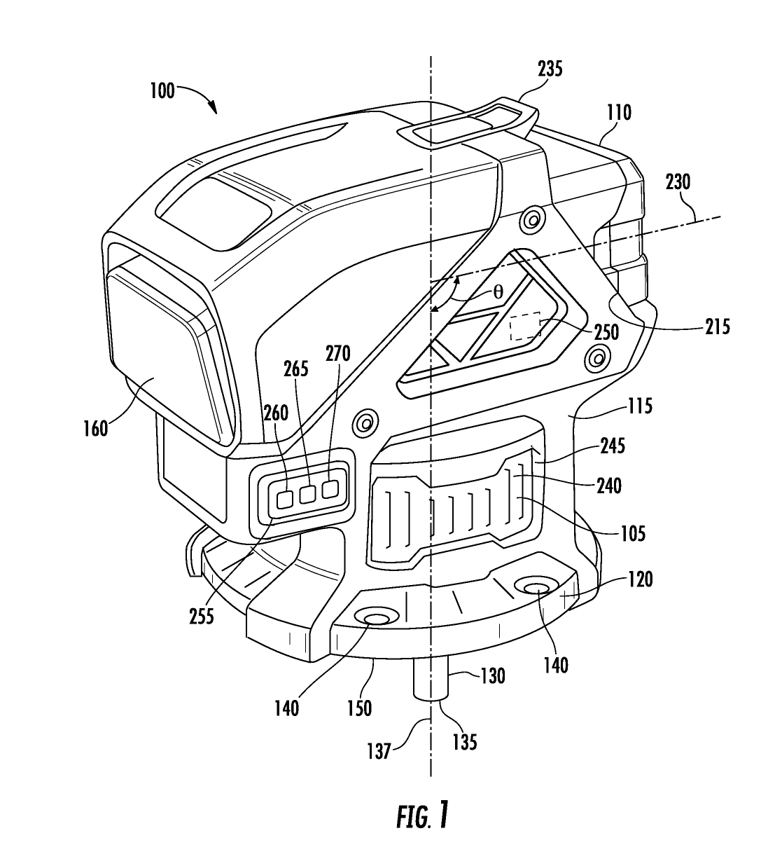

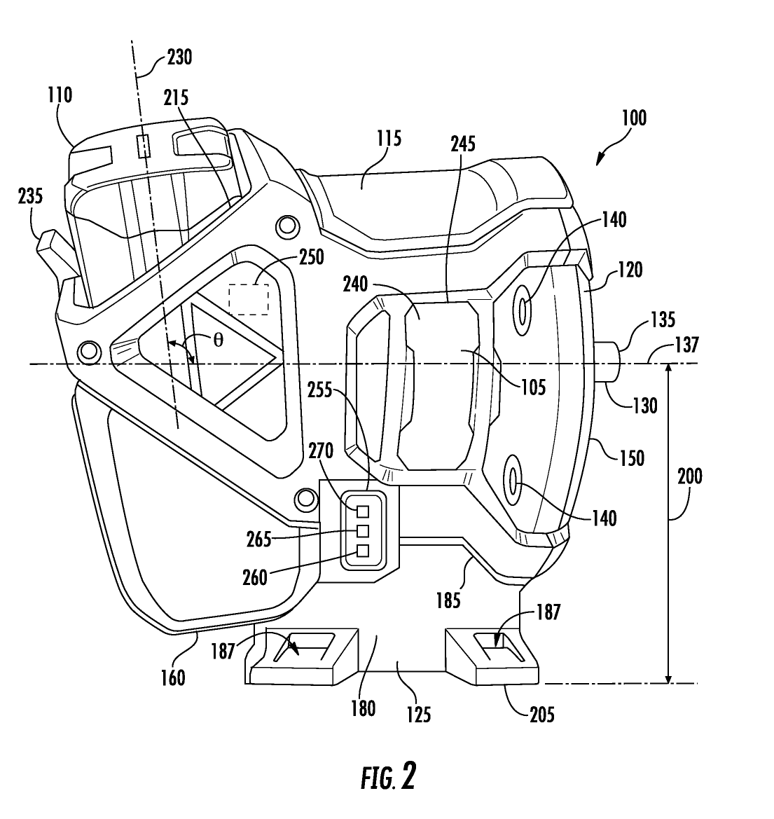

FIGS. 1-2 illustrate an electric powerhead 100 according an exemplary embodiment. The electric powerhead 100 includes an electric motor 105 and an energy storage device or battery 110 that powers the electric motor 105 and other electrical components. The electric powerhead 100 serves as a replacement for the small internal combustion engine frequently used on a variety of equipment, including outdoor power equipment and portable jobsite equipment. Outdoor power equipment includes lawn mowers, riding tractors, snow throwers, pressure washers, tillers, log splitters, zero-turn radius mowers, walk-behind mowers, riding mowers, stand-on mowers, pavement surface preparation devices, industrial vehicles such as forklifts, utility vehicles, commercial turf equipment such as blowers, vacuums, debris loaders, overseeders, power rakes, aerators, sod cutters, brush mowers, portable generators, etc. Outdoor power equipment may, for example, use the electric powerhead 100 to drive an implement, such as a rotary blade of a lawn mower, a pump of a pressure washer, an auger of a snow thrower, and/or a drivetrain of the outdoor power equipment. Portable jobsite equipment includes portable light towers, mobile industrial heaters, and portable light stands.

The electric powerhead 100 also includes a housing 115 with a mounting plate 120 for securing the electric powerhead 100 to a mounting location on a piece of equipment (e.g., to secure the electric powerhead 100 to the deck of a lawn mower). The housing 115 is sized so that the electric powerhead 100 has a similar volume to a comparable small internal combustion engine that provides a similar mechanical output (e.g., power and torque) so that the electric powerhead 100 can be used as a direct replacement for comparable small internal combustion engines.

The mounting plate 120 and a removable support 125 (FIG. 2) allow the electric powerhead 100 to be used as a direct replacement for both comparable vertical shaft small internal combustion engines and comparable horizontal shaft small internal combustion engine. The mounting plate 120 includes a central opening or aperture 127 (FIG. 5) that allows the output shaft 130 of the electric motor 105 to extend through the mounting plate 120. The end 135 of the output shaft 130 is located past the mounting plate 120 outside of the housing 115. The output shaft 130 rotates about an axis of rotation 137.

Referring to FIG. 5, the mounting plate 120 includes two sets of openings with each set arranged in a standard engine mounting pattern (e.g., an SAE or other industry standard for mounting small internal combustion engines). Engine mounting patterns are standardized so that engines produced by different engine manufactures can be mounted to equipment produced by different original equipment manufacturers (OEMs) without having to customize the mounting arrangement between the engine and the equipment. This allows an OEM to offer the same equipment with different engines from different manufacturers to meet the OEM's engine needs or the customer's engine needs. Bolts or other fasteners are inserted through the openings to attach the mounting plate 120 at a desired mounting location. In other embodiments, the mounting plate 120 includes one set of openings arranged in a standard engine mounting pattern. In other embodiments, the mounting plate 120 includes more than two sets of openings with each set arranged in a standard engine mounting pattern.

The first set of openings 140 in the mounting plate 120 is arranged in a standard vertical shaft engine mounting pattern. In the illustrated embodiment, the first set of openings 140 has three openings 140. In a Cartesian coordinate system with the origin 145 located on the axis of rotation 137 at the outer surface 150 of the mounting plate 120 and a y-axis 155 pointing toward the front 160 of the electric powerhead 100 and an x-axis 165 perpendicular to the y-axis, the center point of the first opening 140 is positioned at a distance 141 from the origin 145 in the negative direction along the x-axis and at a distance 142 from the origin 145 in the positive direction along the y-axis, the center point of the second opening 140 is positioned at a distance 143 from the origin 145 in the positive direction along the x-axis and at a distance 144 from the origin 145 in the negative direction along the y-axis, and the third opening 140 is positioned at a distance 146 from the origin 145 in the negative direction along the x-axis and a distance 147 from the origin 145 in the negative direction along the y-axis. In some embodiments, the openings 140 have a diameter of 0.350 inch, the distance 141 is 2.408 inches, the distance 142 is 3.195 inches, the distance 143 is 3.683 inches, the distance 144 is 1.563 inches, the distance 146 is 2.625 inches, and the distance 147 is 3.019 inches.

The second set of openings 170 in the mounting plate 120 is arranged in a standard horizontal shaft engine mounting pattern. In the illustrated embodiment, the second set of openings 170 has four openings 170. The four openings 170 are arranged in a square centered at the origin 145 and spaced apart from each other by a distance 171. In some embodiments, the openings 170 have a diameter of 0.312 inch and the distance 171 is 2.56 inches.

Small internal combustion engines are not freely mountable in any shaft orientation (e.g., vertical, horizontal, angled). Instead, small internal combustion engines are designed for use in specific shaft orientations. Mounting a vertical shaft engine in a horizontal shaft orientation or mounting a horizontal shaft engine a vertical shaft orientation would result in unacceptable engine operation (e.g., smoking, uneven combustion, etc.) and possibly in engine failure. The liquids essential to normal operation of an engine (e.g., oil and fuel) would flow to improper locations due to gravity's effect on these liquids when an engine is mounted in a shaft orientation different than that specified for that particular engine. For example, oil would not pool properly in the sump and instead flow to the combustion chamber of the cylinder and cause unwanted smoking when operating the engine. Even engines that share components between vertical shaft versions and horizontal shaft versions require adaptations to essential components to be used in vertical shaft versions or horizontal shaft versions (e.g., different oil sumps for vertical shaft versions and horizontal shaft versions, different carburetor orientations for vertical shaft versions and horizontal shaft versions, etc.). Because small internal combustion engines are not freely mountable in any shaft orientation, there has been no reason to provide an engine mounting plate having multiple sets of openings with each set arranged in a standard engine mounting pattern. In contrast, the electric powerhead 100 is freely mountable in any shaft orientation (e.g., vertical, horizontal, angled). The electric powerhead 100 does not require liquids like oil or fuel for operation and therefore is not subject to the same design constraints related to these liquids as small internal combustion engines. This allows the same electric powerhead 100 to be used in vertical shaft orientations, horizontal shaft orientations, and angled shaft orientations. Because of this mounting flexibility, the electric powerhead 100 is provided with the mounting plate 120 that allows for mounting the electric powerhead 100 in either a vertical shaft orientation or a horizontal shaft orientation through the use of the sets of openings 140 and 170 arranged in standard engine mounting patterns.

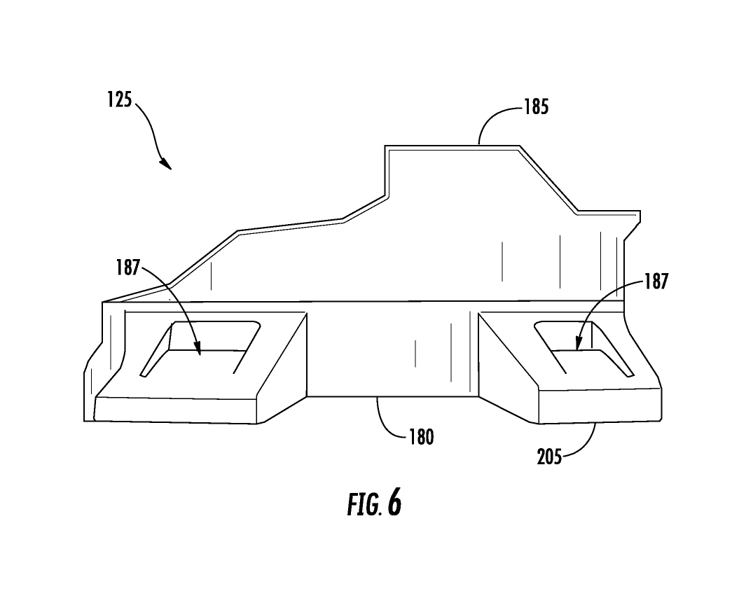

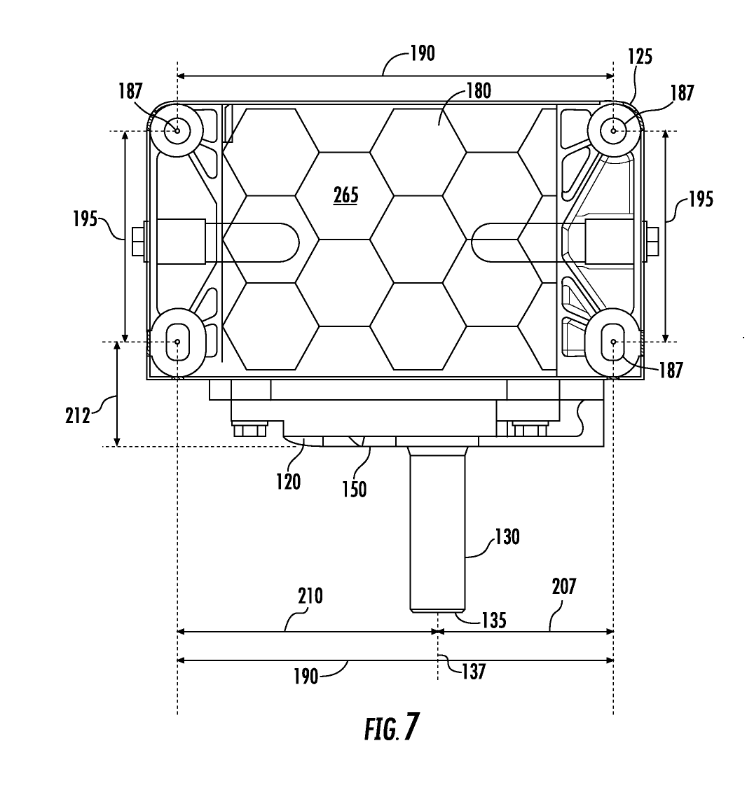

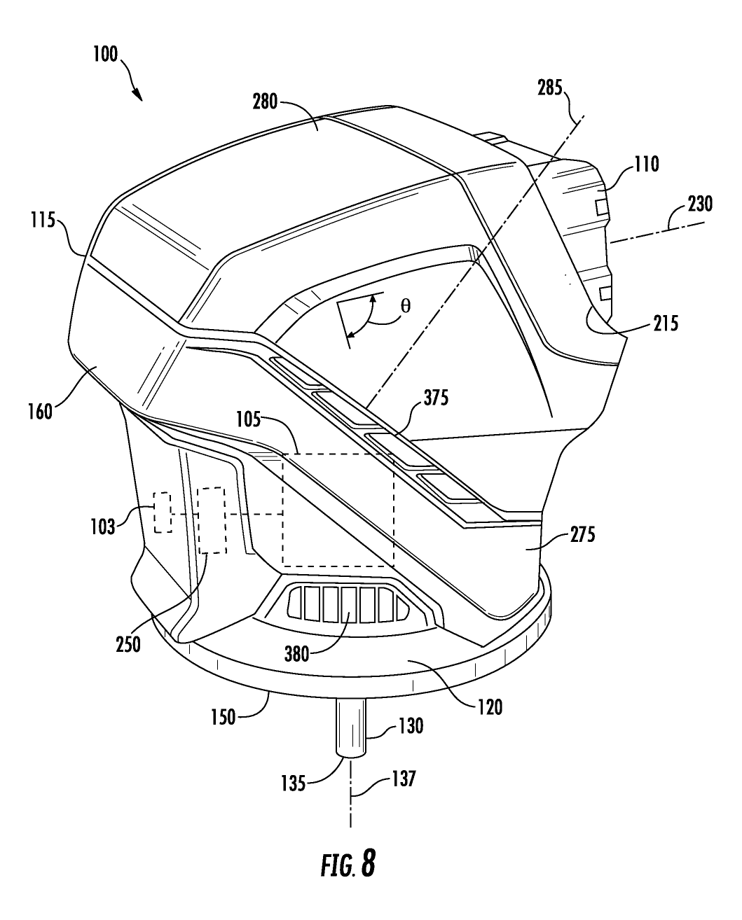

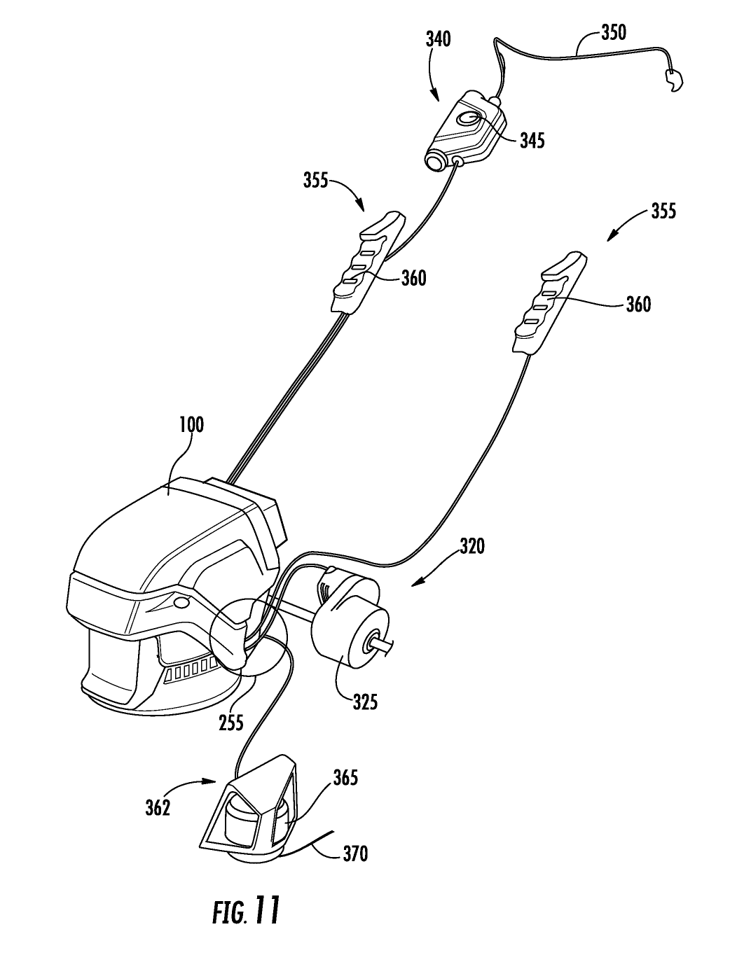

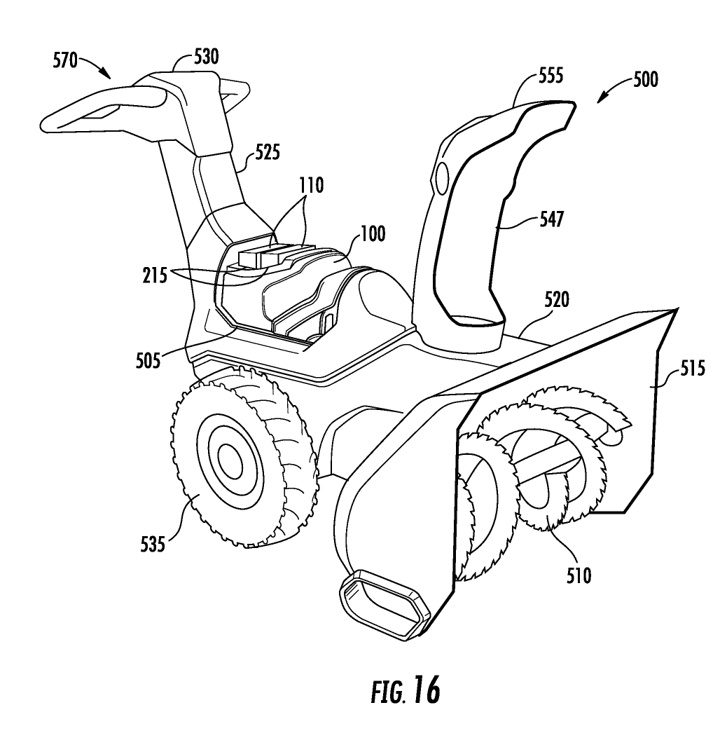

When the electric powerhead 100 is mounted in a vertical shaft orientation (FIG. 1), the mounting plate 120 supports the electric powerhead 100 on the equipment the electric powerhead is used with (e.g., the lawnmower of FIG. 10). When the electric powerhead 100 is mounted in a horizontal shaft orientation (FIG. 2), the removable support 125 is attached to the housing 115 to support the electric powerhead on the equipment the electric powerhead 100 is used with (e.g., the snow thrower of FIG. 16). As shown in FIGS. 6-7, the removable support 125 includes a base 180 and a cradle 185. The base 180 includes a set of openings 187 arranged in a standard horizontal engine support pattern. Bolts or other fasteners are inserted through the openings 187 to attach the base 180 at a desired mounting location. Like the engine mounting patterns discussed above, horizontal engine support patterns are standardized. In the illustrated embodiment, the set of openings 187 includes four openings 187 arranged in a rectangle having a first distance or width 190 between the center points of two openings 187 and a second distance or depth 195 between the center points of two openings 187. In some embodiments, the width 190 is 6.38 inches and the depth 195 is 3.25 inches In some embodiments, some or all of the openings 170 have a diameter of 0.35 inch. In the illustrated embodiment, the front openings 187 (i.e., those closest to the outer surface 150 of the mounting plate 120) are elongated slots. In some embodiments, the elongated slots have a diameter of 0.35 inch and a length of 0.55 inch. When the removable support 125 is attached to the housing 115 (e.g., with bolts or other fasteners), the cradle 185 supports and positions the housing 115 so that the axis of rotation 137 of the output shaft 130 is located a standard horizontal shaft engine height 200 above the bottom surface 205 of the base 180 and so that the axis of rotation 137 is located a horizontal distance 207 from one of the front openings 187 and is located a horizontal distance 210 from the other of the front openings 187. In some embodiments, the height 200 is 4.17 inches, the distance 207 is 2.6 inches and the distance 210 is 3.78 inches. The center points of the front openings 187 in the base 180 (i.e., those closest to the outer surface 150 of the mounting plate 120) are spaced a distance 212 from the outer surface 150 of the mounting plate 120. In some embodiments, the distance 212 is 1.40 inches. Like the engine mounting patterns and support patterns, discussed above, the height of the axis of rotation of the output shaft of a horizontal shaft engine above a mounting surface, the location of the axis of rotation relative to the supporting pattern, and the location of the supporting pattern relative to the mounting plate are standardized.

Standard vertical shaft engine mounting patterns, standard horizontal shaft engine mounting patterns, standard horizontal engine support patterns, standard horizontal shaft engine heights, and other engine standards can be found in the included Appendix included in U.S. Provisional Patent Application No. 62/413,802, filed Oct. 27, 2016, which is incorporated herein by reference in its entirety.

As shown in FIGS. 1-2, the housing 115 includes a battery receptacle 215 configured to receive a removable battery 110. The removable battery 110 is able to be attached to and removed from the battery receptacle 215 without the use of tools. In other embodiments, the battery 110 may be attached to the housing 115 in a fixed manner that would require the use of tools to remove the battery 110 from the housing. The battery receptacle 215 and the battery 110 include contacts that are configured to engage or connect with each other to complete an electrical circuit when the battery 110 is attached to the battery receptacle 215. This allows the battery 110 to provide electricity to the electric motor 105 and other electrical components as will be explained in more detail below. The battery 110 includes multiple electrochemical battery cells. According to an exemplary embodiment, each cell is a cylindrical lithium ion (Li-ion) cell that extends along a longitudinal cell axis. In other embodiments, the cells may be differently shaped (e.g., prismatic cells) or may have different battery chemistries (e.g., nickel-cadmium, lead-acid, nickel metal hydride, nickel-zinc, etc.). The battery 110 may be provided in different configurations providing different energy capacities and voltage ratings. For example, in some embodiments the battery 110 provides between 150 and 500 watt hours of energy at a voltage rating of 72 volts. In other embodiments, different energy capacities and voltage ratings are provided. In some embodiments, multiple battery receptacles 215 are provided to increase the amount of electrical energy available for use by the electric powerhead 100.

The battery receptacle 215 is positioned in the housing 115 so that a straight axis of insertion 230 along which the battery 110 is inserted into the battery receptacle 215 is positioned at an angle θ relative to the axis of rotation 137 of the output shaft 130 in a vertical plane that includes the axis of rotation 137. This orientation allows the battery 110 to be readily inserted into and removed the battery receptacle 215 in both the vertical shaft orientation (FIG. 1) and the horizontal shaft orientation (FIG. 2). Applicant has found that an angle θ between 90 degrees and 135 degrees allows for easy access to the battery receptacle 215 for inserting and removing the battery 110. The battery receptacle 215 includes a stop surface that is configured to contact a face or other surface of the battery 110 when the battery 110 is inserted into the battery receptacle 215 to limit the insertion of the battery 110 into the battery receptacle 215. In some embodiments, the axis of insertion 230 is orthogonal to the stop surface of the battery receptacle 215. The stop surface is positioned at an angle relative to a horizontal plane including the axis of rotation 137 of the output shaft 130. Applicant has found that a stop surface angle between 0 degrees and 45 degrees allows for easy access to the battery receptacle 215 for inserting and removing the battery 110. In some embodiments, when the battery 110 is attached to the battery receptacle 215, the longitudinal axes of the battery cells of the battery 110 are parallel to the axis of insertion 230.

In some embodiments, the battery 110 and the battery receptacle 215 include mechanical aligning features to ensure proper alignment between the battery 110 and the battery receptacle 215 and/or to guide the battery 110 into the battery receptacle 215. For example, the battery 110 includes a protrusion and the battery receptacle 215 includes a corresponding slot to receive the protrusion. As shown in FIGS. 1-2, in some embodiments, the housing 115 includes a lock or latch 235 to secure the battery 110 to the battery receptacle 215. In other embodiments, the battery 110 includes the lock or latch for securing the battery 110 to the battery receptacle 215.

The battery 110 may be removed and attached to a charging station to charge the battery 110. The charging station connects to a source of electricity (e.g., the power grid, a generator, etc.) and may include a transformer. Alternatively or additionally, the battery 110 or the housing 115 includes an outlet or port to connect to a charging device. The charging device includes a plug and a cord to connect the outlet to a source of electricity (e.g., the power grid, a generator, etc.) and may include a transformer.

The electric motor 105 is positioned within the housing 115. The electric motor 105 may be directly supported by the housing 115 or supported by a cradle or other support structure located within the housing 115. In some embodiments, the electric motor 105 is positioned within the housing 115 with one or more portions 240 of the electric motor 105 exposed through or extending through openings 245 in the housing 115. In different embodiments, the electric motor 105 is provided with different power ratings (e.g. 1,500 watts, 2,500 watts, or 3,500 watts). In addition to the output shaft 130, the electric motor 105 includes a stator and a rotor. The rotor and the output shaft 130 rotate about the axis of rotation 137 when the electric motor 105 is activated.

The electric powerhead 100 also includes a controller or processing circuit 250 for controlling operation of electrical components of the powerhead 100. In some embodiments, the controller 250 also controls operation of and/or communicates with electrical components coupled to the electric powerhead 100 (e.g., electrically coupled by wires or wirelessly coupled). The controller can include a processor and memory device. The processor can be implemented as a general purpose processor, an application specific integrated circuit (ASIC), one or more field programmable gate arrays (FPGAs), a group of processing components, or other suitable electronic processing components. The memory device (e.g., memory, memory unit, storage device, etc.) is one or more devices (e.g., RAM, ROM, Flash memory, hard disk storage, etc.) for storing data and/or computer code for completing or facilitating the various processes, layers and modules described in the present application. The memory device may be or include volatile memory or non-volatile memory. The memory device may include database components, object code components, script components, or any other type of information structure for supporting the various activities and information structures described in the present application. According to an exemplary embodiment, the memory device is communicably connected to the processor via a processing circuit and includes computer code for executing (e.g., by processing circuit and/or processor) one or more processes described herein. The controller 250 may be positioned in and/or attached to the housing 115.

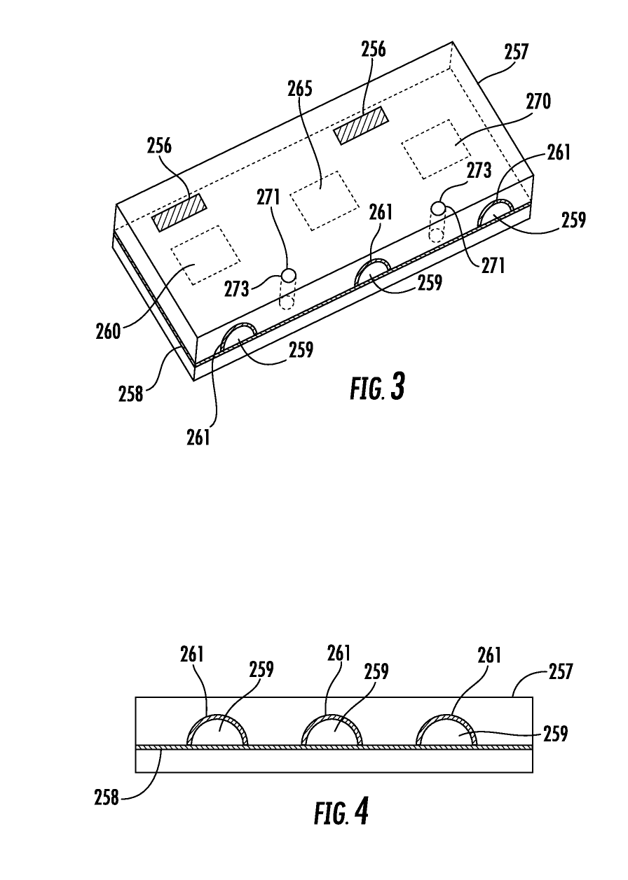

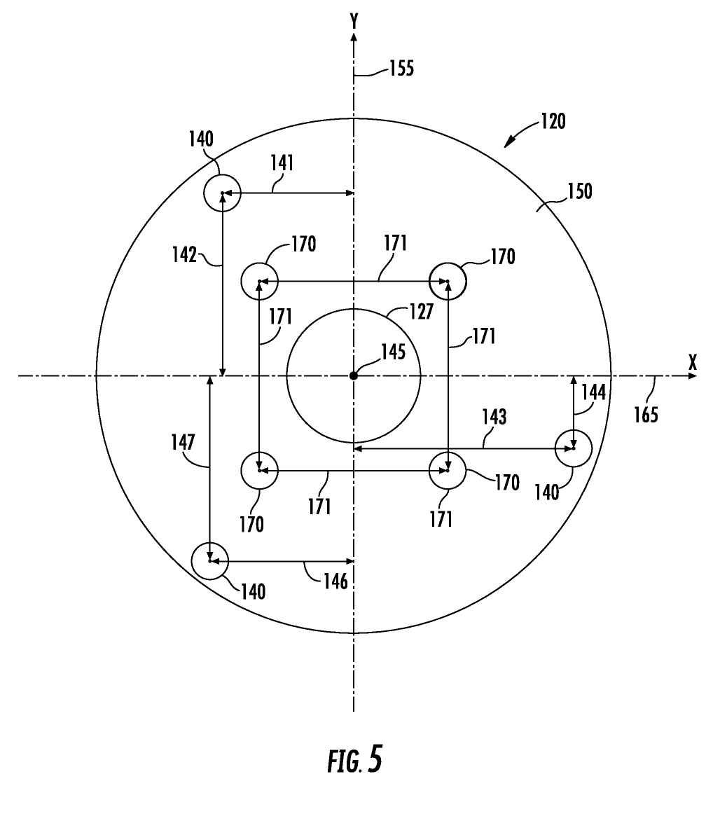

An accessory interface 255 including one or more power ports or contacts 260 and communication ports or contacts 265 is provided to allow the electric powerhead 100 to power and communicate with external electrical components (i.e., external to or separate from the electric powerhead 100). As shown in FIGS. 3-4, in some embodiments, the power ports or contacts 260 and communication ports or contacts 265 are covered by a cover 257 which, either when connected or disconnected to external electrical components, provides a water-tight seal such that the exposure of electric components to water is minimized. The cover 257 includes one or more hinges 256 such that the cover 257 can move between an open and a closed position. In other embodiments, the cover 257 does not include hinges such that the cover 257 can be completely removed from the accessory interface 255. When in the closed position, the cover 257 is secured to the accessory interface 255 using screws 271 or other types of fasteners (e.g., bolts) inserted through openings 273 in the cover 257 and engaged with the accessory interface 255. To open and close the cover 257, a user is required to use tools (e.g., wrench, socket) to attach and detach the fasteners 271. A seal 258 (e.g., gasket, O-ring, etc.) is provided between the cover 257 and the accessory interface 255 to seal the bottom perimeter face of the cover 257 to the interface 255 so as to minimize exposure of water or other fluids to the electrical components. As shown in FIG. 4, the cover 257 includes passages 259 (e.g., through-holes, channels, etc.) structured to allow electrical cords to pass through and interface with the power ports or contacts 260 and communication ports or contacts 265 within the cover 257. A passage seal 261 (e.g., gasket, O-ring, etc.) is provided along the inner wall of each passage 259 to seal the cover 257 (or the cover 257 and the accessory interface 255) to components passing through each passage 259. In some embodiments, the cover 257 is a snap-to-connect cover.

The accessory interface 255 is electrically coupled to the battery receptacle 215 so that the battery 110 can provide electricity to external electrical components via a power port 260. The accessory interface is electrically coupled to the controller 250 to provide data communications (e.g., transmission and receipt of input and output signals or other data streams) with external electrical components via a communication port 265. In some embodiments, the accessory interface 255 includes a wireless transceiver 270 to provide for wireless communication with an external electrical component. In some embodiments, a communication port 265 can be used to allow an OEM or service provider to send controller programming updates (e.g., firmware updates, software updates) to the controller 250. In some embodiments, the controller 250 is programmed to detect the type of equipment the electric powerhead 100 is being used with. For example, the controller 250 can be programmed to detect equipment-specific external electrical components (e.g., plug-and-play components) and adjust operating characteristics of the electric powerhead 100 according to instructions specific to that equipment. For example, the controller 250 could detect walk behind lawn mower user controls connected to the accessory interface 255 and limit the rotational speed of the electric motor 105 to 3200 revolutions per minute (RPM) and could detect pressure washer user controls connected to the accessory interface 255 and limit the rotational speed of the electric motor 105 to 3600 RPM.

In some embodiments, the controller 250 is configured to detect the type of user controls, such as lawn mower controls, connected to the accessory interface 255 and provide a minimum power to the electric motor 105 to provide cutting at a certain rotational speed (e.g., RPM). Typically, gas-powered lawn mowers are controlled (e.g., governed) to maintain a constant output speed (e.g., blade speed). In some embodiments, the powerhead 100 is configured to maintain a constant output speed by drawing a minimum amount of current from the battery 110 to meet the output speed. Alternatively, the powerhead 100 can run to provide a targeted power output (e.g., to the mower blade) and vary current draw and output speed (e.g., blade speed) to maintain the targeted power output. In some embodiments, the targeted power control can be combined with a minimum output speed control so that the powerhead 100 provides the minimum output power, but not if doing so would cause the output speed (e.g., blade speed) to fall below a minimum speed. In that situation, the powerhead 100 would run at the minimum output speed. In some embodiments, the controller 250 is configured to monitor and control the amount of power delivered to the electric motor 105 to preserve life of the battery 110.

In some embodiments, the one or more power ports or contacts 260 provide electricity to remote user controls (e.g., hand controls 340, 570 described further herein). When a remote user control is plugged into the power port 260, the controller 250 is configured to detect the presence of the remote user control. Upon detection of the remote user control plugged into the power port 260, the controller 250 allows the remote user control to override any on-board control. Thus, when a remote user control is not plugged into the power port 260, a user can control the powerhead 100 using on-board controls. As noted above, the controller 250 can perform other functions upon detection of the remote user controls, such as limiting the rotational speed of the electric motor 150.

In various contemplated embodiments, different hierarchies of controls can be used. First, the remote user controls can be given preference over the on-board controls such that the remote user controls override inputs to the on-board controls. Second, the on-board controls can be given preference over the remote user controls such that the on-board controls override the remote user controls. Third, if the remote user controls are present (e.g., detected) the on-board controls are disabled. Fourth, in some embodiments, the powerhead 100 off control always turns the powerhead 100 off without regard to where off control is located (e.g., remotely, on-board).

In some embodiments, the electric powerhead 100 includes a speaker and a wireless transceiver (e.g., Bluetooth) to communicate with a user device (e.g., smart phone, tablet, laptop, or other smart device) to play audio over the speaker. This enables the user to use the electric powerhead as a wireless radio or speaker.

In some cold weather embodiments, it may be useful to warm up the cells of the battery 110 before using the battery 110 to power the electric motor 105 or external electrical components. A warm-up system or circuit is provided so that cells of the battery 110 discharge for a period of time to warm up the cells before the electric motor 105 or other external electrical components are activated.

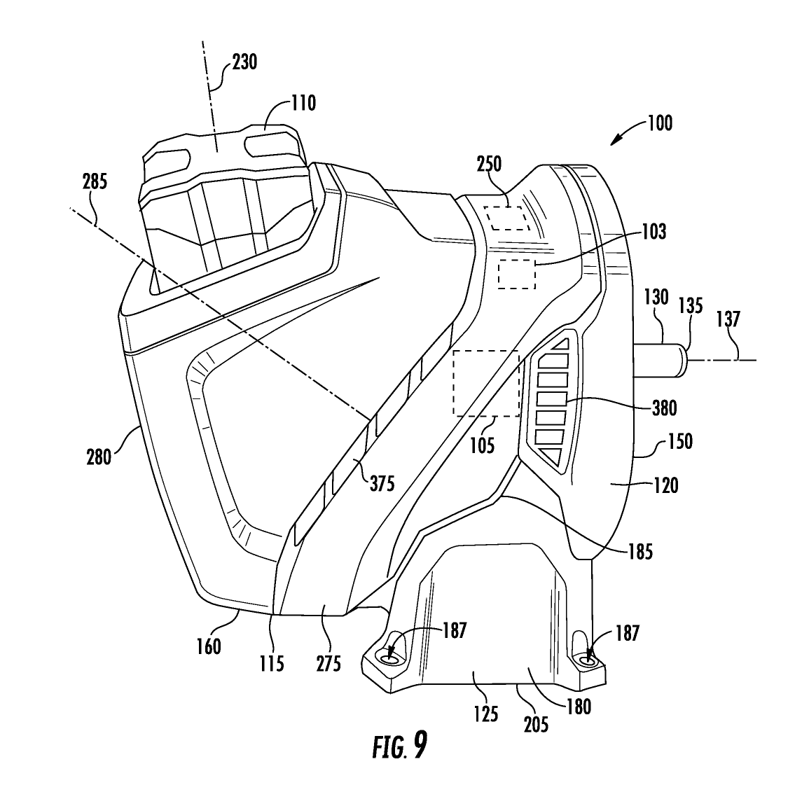

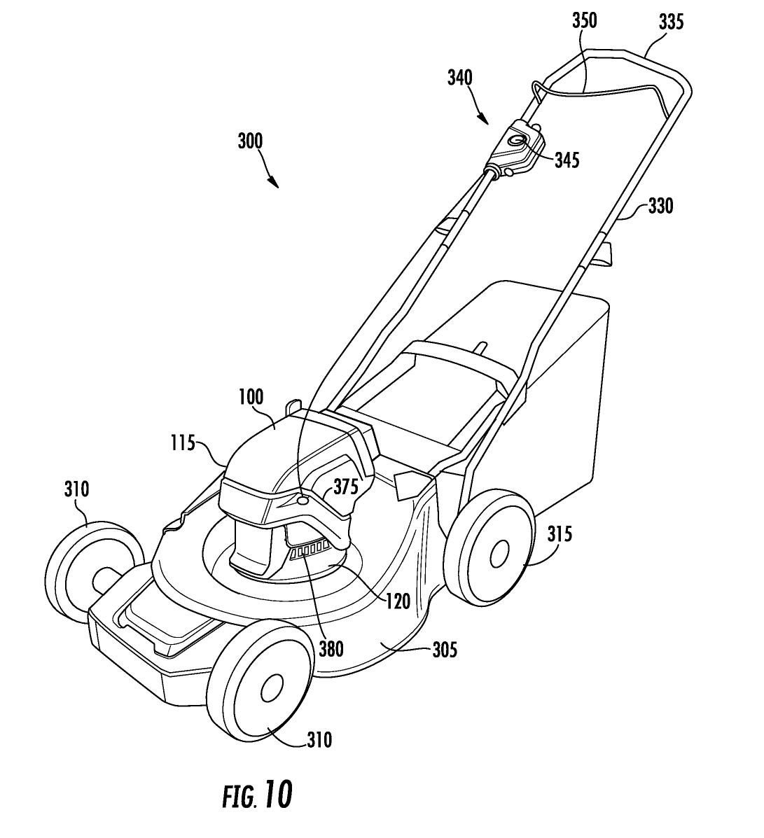

FIGS. 8-9 illustrate an alternative embodiment of the electric powerhead 100 in which the housing 115 includes two portions 275 and 280 that are able to rotate relative to one another. The motor portion of the housing or motor housing 275 includes the electric motor 105, the mounting plate 120, and the controller 250. The battery receptacle portion or battery receptacle housing 280 includes the battery receptacle 215. A rotatable joint or coupling rotatably couples the motor housing 275 and the battery receptacle housing 280 together. In some embodiments, wires connecting the battery receptacle 215 to one or more electrical components (e.g., the electric motor 105, the controller 250, etc.) of the motor housing 275 pass through the rotatable joint to allow the motor housing 275 and the battery receptacle housing 280 to rotate relative to one another without damaging the electrical connections between electrical components of the two housings. The rotatable joint allows the motor housing 275 and the battery receptacle housing 280 to rotate about a housing axis of rotation 285. In some embodiments, the housing axis of rotation 285 is positioned at an angle to the axis of rotation 137 of the output shaft 130 of the electric motor 105. In some embodiments, the housing axis of rotation 285 is parallel to the axis of rotation 137 of the output shaft 130 of the electric motor 105. In some embodiments, the housing axis of rotation 285 is collinear with the axis of rotation 137 of the output shaft 130 of the electric motor 105. In some embodiments, the housing axis of rotation 285 is not collinear with the axis of rotation 137 of the output shaft 130 of the electric motor 105.

The ability to rotate the motor housing 275 and the battery receptacle housing 280 relative to each other allows the battery receptacle 215 to be readily accessible to the user. User access to the battery receptacle 215 may be limited due to the relative positioning of the electric powerhead 100 and other components of the equipment the electric powerhead is used with. The ability to rotate the motor housing 275 and the battery receptacle housing 280 relative to each other allows the OEM to customize the electric powerhead 100 for use in a particular piece of equipment as needed to provide easy access to the battery receptacle 215. The motor housing 275 and the battery receptacle housing 280 may be secured to one another in the desired position by one or more fasteners, locks, latches, or other securing devices. The securing devices may be one-time securing devices to limit the ability of the customer, rather than the OEM, to rotate the motor housing 275 and the battery receptacle housing 280 relative to one another.

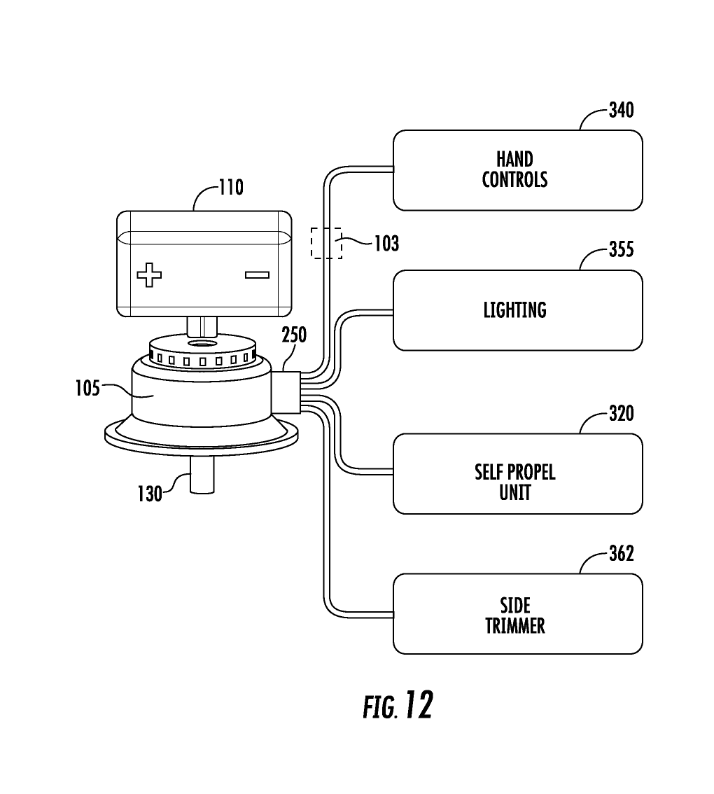

FIGS. 10-12 illustrate a walk behind lawn mower 300 according to an exemplary embodiment. The lawn mower 300 includes an electric powerhead 100 attached to a mower deck 305 in a vertical shaft orientation. When the electric motor 105 is activated, the output shaft 130 drives a blade positioned underneath the mower deck 305 to cut grass. The lawn mower 300 also includes a pair of free-wheeling front wheels 310 and a pair of drive wheels 315. Each drive wheel 315 is driven by a self-propel unit 320 that includes an electric wheel motor 325. The electric wheel motor 325 includes an output shaft that is coupled to the drive wheel 315. The electric wheel motor 325 can be activated to rotate the drive wheel 315 in a forward direction, in a reverse direction, and at varying speeds in either direction. A handle 330 extends from the rear of the mower deck 305 and includes a bar 335 for the user to grasp to direct the travel of the lawn mower 300. User hand controls 340 including a start button 345 and a rotatable bail 350 are provided near the bar 335 to allow the user to provide operating commands (e.g., to activate or stop rotation of the blade, to activate or stop operation of the drive wheels 315, to control operation of other components of the lawn mower, including lighting units 355). Other types of user hand controls may be provided in other embodiments, including one or more switches, buttons, sliders, touch screens, or other user input devices. One or more lighting units 355 including one or more light sources 360 (e.g., light bulbs, LEDs, etc.) can be attached to the handle 330, mower deck 305, electric powerhead 100 or elsewhere to provide lighting as may be needed by the user. One or more side trimmers 362 including an electric motor for driving a string trimmer head 365 can be attached to the mower deck 305. The side trimmers 362 allow the user to trim areas of grass or other vegetation that are difficult to reach with the blade (e.g., due to contact between the mower deck 305 and an obstruction like a tree, gardening feature, or wall) by providing a rotating string trimmer line 370 that extends to a distance outward from the mower deck 305 and the wheels 310 and 315, which enables the string trimmer line 370 to reach areas that cannot be reached with the blade. Providing the side trimmers 362 as a component of the lawn mower 300 allows the user to trim hard to reach areas without having to use a separate handheld string trimmer, thereby reducing the user time spent tending the lawn.

The self-propel units 320, the user hand controls 340, the lighting units 355, and the side trimmers 362 are electrically coupled to the accessory interface 255 via the power and communication ports 260 and 265 so that the battery 110 of the electric powerhead 100 provides power to these external electrical components and the controller 250 of the electric powerhead 100 is in communication with these external electrical components and can send and receive inputs and outputs to and from the external electrical components to control the electric motor 105, the battery 110, and the external electrical components (e.g., to turn on/off the lighting units 355 or the side trimmers 362 in response to a user input provided via the user hand controls 340). Communication may also be established wirelessly via the wireless transceiver 270 to the external electrical components. Different embodiments of a lawn mower may include more, fewer, or different combinations of external electrical components. Other external electrical components include electric motor driven seeders, fertilizers, spreaders, vacuums, blowers, etc.

In some embodiments, at least a portion of the user hand controls, referred to as on-board controls, are positioned on the housing 115 of the powerhead 100. In some embodiments, when the user hand controls 340 positioned remote from the housing 115 (as described above) are plugged into the accessory interface 255 (e.g., at power port 260), the controller 250 overrides inputs received from the on-board controls and allows the remote user hand controls 340 to provide the control inputs to the controller 250 for operating the powerhead 100.

In some embodiments, the powerhead 100 includes a motor speed sensor to determine motor speed. The output shaft is “braked” by shorting the electric motor 105 to stop the rotation of the motor 105. The controller 250 can use input from the motor speed sensor to determine successful braking and stop shorting the motor 105 when the motor speed reaches zero. A feedback loop can be included to control the output signal for shorting the motor 105.

As shown in FIGS. 8-10, the housing 115 includes motor intake air vent 375 and motor exhaust air vent 380 that allow cooling air to be drawn into the housing 115, cool the electric motor 105, and then have the warmed air exhausted from the housing 115. The vents 375 and 380 may include one or more openings, screens, or other structures that allow air to flow into or out of the housing 115. The vents 375 and 380 are formed in the motor housing 275. In some embodiments, a fan is coupled to the rotor and rotates to cause the cooling air when the electric motor 105 is activated. In conventional electric powerheads, the exhaust vents are positioned on the bottom of the motor mounting plate and therefore exhaust to the same space in which the implement driven by the powerhead resides (e.g., exhaust underneath the mower deck 305). This conventional arrangement allows for the potential of debris (e.g., grass clippings from a blade powered by the electric powerhead) to enter through the motor exhaust vent potentially inhibiting the flow of cooling air over the motor or causing other unwanted operating conditions. Positioning the motor exhaust air vent 380 of the electric powerhead 100 above the mounting plate 120 (when the electric powerhead 100 is in the vertical shaft orientation), the potential for debris to enter the motor exhaust air vent 380 from the blade driven by the electric powerhead is reduced because the motor exhaust air vent 380 is located above the mower deck 305. As shown in FIGS. 8-9, the outer surface 150 of the mounting plate 120 is positioned between the end 135 of the output shaft 130 and the motor intake air vent 375, the outer surface 150 of the mounting plate 120 is positioned between the end 135 of the output shaft 130 and the motor exhaust air vent 380, and the outer surface 150 of the mounting plate 120 is positioned between the end 135 of the output shaft 130 and the stator of the electric motor 105.

In some embodiments, an intake air filter is provided upstream of the motor intake air vent 375 to limit the intake of debris into the housing 115 with the intake of air through the vent 375. In some embodiments, the intake air filter includes a housing and a filter cartridge removably inserted into or attached to the housing. The filter cartridge includes filter media for filtering the air flow through the intake air filter. In some embodiments, the housing and/or the filter cartridge are arranged to provide cyclonic filters before filtering by the filter media by inducing a cyclonic airflow to remove debris from the airflow. In some embodiments, the electric motor 105 drives the fan used to draw air into the motor intake air vent 375 in an opposite direction to clear debris from the motor intake air vent 375 and/or the intake air filter.

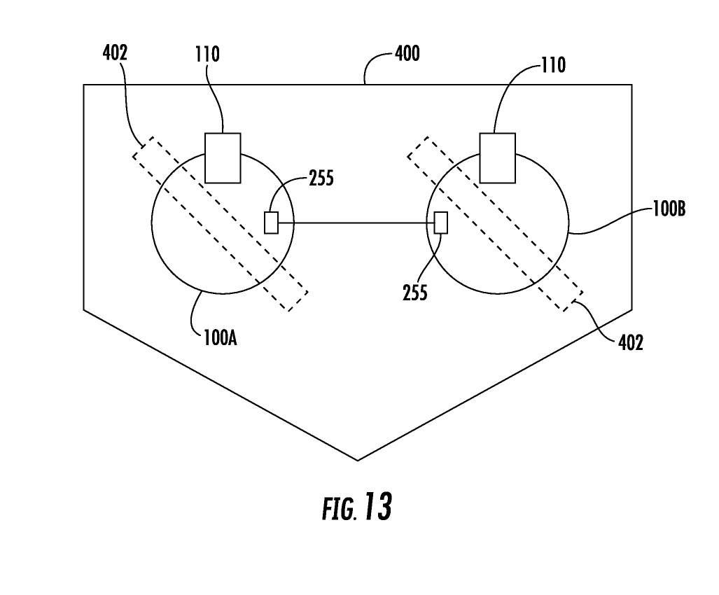

In some embodiments, multiple electric powerheads 100 may be used on the same piece of equipment. For example, as shown in FIG. 13, for a wide area walk behind mower deck 400 having multiple blades 402 positioned below the mower deck 400, one electric powerhead 100A is attached to the mower deck 400 in a vertical shaft orientation to drive the first blade 402 and a second electric powerhead 100B is attached to the mower deck 400 in a vertical shaft orientation to drive the second blade 402. The two powerheads 100A and 100B are connected to one another (e.g., by a wired or wireless connection) between the accessory interfaces 255 of the electric powerheads 100A and 100B so that each of the electric powerheads 100A and 100B is able to communicate send and receive information and instructions about operational and other statuses of the other powerhead. For example, user hand controls are connected to the first electric powerhead 100A with necessary communications for operating the second electric powerhead 100B are sent from the user hand controls to the first electric powerhead 100A and then on to the second electric power head 100B. Using a wired connection between the two electric powerheads 100A and 100B also allows the electric powerheads 100A and 100B to share electricity provided by the batteries 110 associated with each of the individual electric powerheads 100A and 100B.

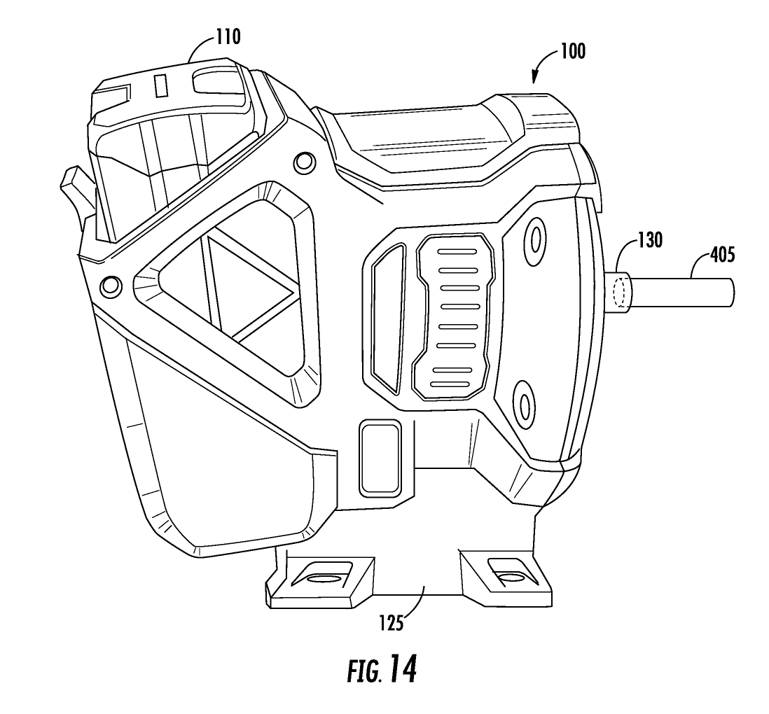

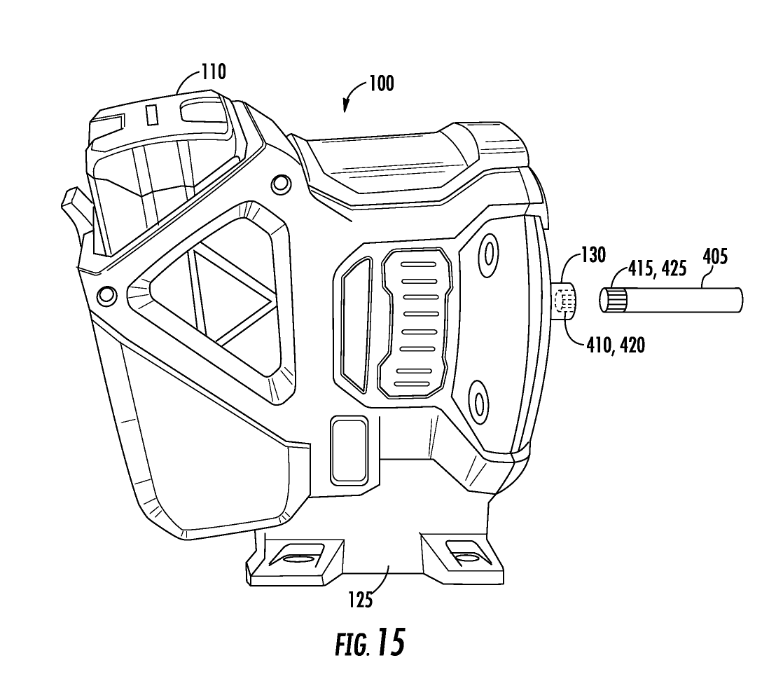

As shown in FIGS. 14-15, in some embodiments of the electric powerhead 100, the output shaft 130 of the electric motor 105 includes a removable output shaft or power takeoff 405. Electric powerheads used on different end equipment may require different power takeoffs 405. For example, the length, diameter, keyway configuration and attachment means used to attach an implement or component to the output shaft 130 of the electric motor 105 may vary depending on the end product powered by the electric powerhead 100. The motor output shaft 130 includes a coupling 410 that is configured to receive, attach, or otherwise mate with a related coupling 415 of the removable power takeoff 405. For example, as illustrated, the coupling 410 of the motor output shaft 130 includes an internal spline 420 that receives a corresponding external spline 425 of the coupling 415 of the removable power takeoff 405. As another example, the power takeoff shaft and motor output shaft may include a ball detent mechanism or other coupling arrangement that allows the power takeoff 405 to be removably attached to the motor output shaft 130. Because the electric motor 105 provides a steady torque output (as opposed to the varying torque output of an internal combustion engine where different strokes of the combustion process apply slightly different torques to the crankshaft of the engine), the removably attachable power take off 405 is unlikely to become disconnected from the motor output shaft 130 during operation of the electric motor 105.

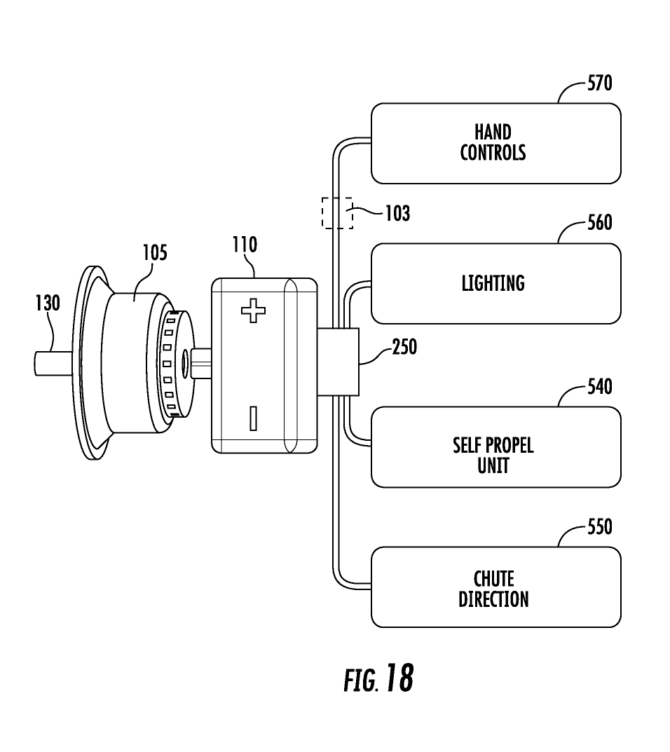

FIGS. 16-18 illustrate a snow thrower 500 according to an exemplary embodiment. The snow thrower 500 includes an electric powerhead 100 attached to a mounting location or platform 505 in a horizontal shaft orientation. The electric powerhead 100 includes two battery receptacles 215 and two removable batteries 110, thereby providing additional electrical energy for use by the electric powerhead 100 and any external electrical components connected to the electric powerhead 100. The snow thrower 500 includes an auger 510 positioned within an auger housing 515. The auger 510 is driven by the electric motor 105 of the electric powerhead 100 and is mechanically connected to the output shaft 130 (e.g., by a transmission). The auger housing 515 is located at the front of the body 520 of the snow thrower 500. A handle 525 extends from the rear of the body 520 and includes a user interface 530 for the user to grasp to direct the travel of the snow thrower 500. The snow thrower 500 also includes a pair of drive wheels 535. Each drive wheel 535 is driven by a self-propel unit 540 that includes an electric wheel motor 545. The electric wheel motor 545 includes an output shaft that is coupled to the drive wheel 535. The electric wheel motor 545 can be activated to rotate the drive wheel 535 in a forward direction, in a reverse direction, and at varying speeds in either direction. A chute 547 for directing snow output from the snow thrower 500 is rotatably connected to the body 520. A chute direction electric motor 550 rotates the chute 547 to a desired direction. A deflector 555 is connected to the chute 547 to control the angle at which snow is output from the chute 547. A deflector electric motor may be provided to control the position of the deflector 555 relative to the chute 547. One or more lighting units 560 including one or more light sources 565 (e.g., light bulbs, LEDs, etc.) can be attached to the auger housing 515, the body 520, the handle 525, the electric powerhead 100 or elsewhere to provide lighting as may be needed by the user. User hand controls 570 are provided at the user interface 530 to allow the user to provide operating commands (e.g., to activate or stop rotation of the auger 510, to activate or stop operation of the drive wheels 535, to set the maximum speed of the snow thrower, to control the direction of travel of the snow thrower, to control the position of the chute 547, to control the position of the deflector 555, and to control operation of other components of the lawn mower, including lighting units 560). Types of user hand controls include one or more switches, buttons, sliders, levers, dials, touch screens, positions sensors, torque sensors, force sensors, and other user input devices.

The self-propel units 540, the chute direction electric motor 550, the lighting units 560, and the user hand controls 570, are electrically coupled to the accessory interface 255 via the power and communication ports 260 and 265 so that the batteries 110 of the electric powerhead 100 provide power to these external electrical components and the controller 250 of the electric powerhead 100 is in communication with these external electrical components and can send and receive inputs and outputs to and from the external electrical components to control the electric motor 105, the battery 110, and the external electrical components (e.g., to turn on/off the lighting units 560 in response to a user input provided via the user hand controls 570, to control the speed and direction of rotation of the drive wheels 535 in response to a user input provided via the user hand controls 570). Communication may also be established wirelessly via the wireless transceiver 270 to the external electrical components. Different embodiments of a snow thrower may include more, fewer, or different combinations of external electrical components. Other external electrical components include electric motor driven salt spreaders, blowers, etc.

In some embodiments, at least a portion of the user hand controls, referred to as on-board controls, are positioned on the housing 115 of the powerhead 100. When the user hand controls 570 positioned remote from the housing 115 (as described above) are plugged into the accessory interface 255 (e.g., at power port 260), the controller 250 overrides inputs received from the on-board controls and allows the remote user hand controls 570 to provide the control inputs to the controller 250 for operating the powerhead 100.

In some embodiments of the electric powerhead 100, the controller 250 is programmed to prioritize distribution of electricity to the electric motor 105 and any external electrical components. For example, as the charge of the battery or batteries 110 decreases, some electrical components may be turned off (e.g., the side trimmers 362 or the lighting units 355) to extend the available runtime for other components (e.g., the electric motor 105 that drives the blade and the user hand controls 570 that control operation of the lawn mower 300). Alternatively, the electric motor 105 could be turned off first, the lighting units 355 turned off second, and the self-propel units 320 turned off third so that the user can return the lawn mower 300 to a garage or storage location utilizing the self-propel units 320 when the battery charge level is low. Battery charge level may be displayed to the user by a display device (e.g., screen, light, LED, etc.).

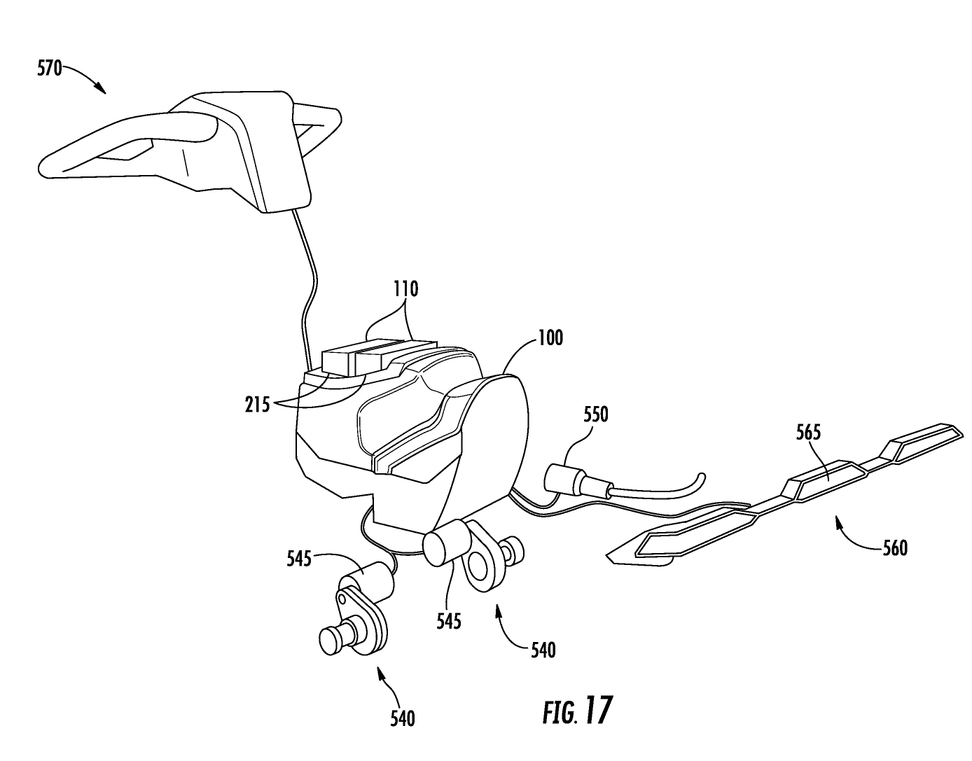

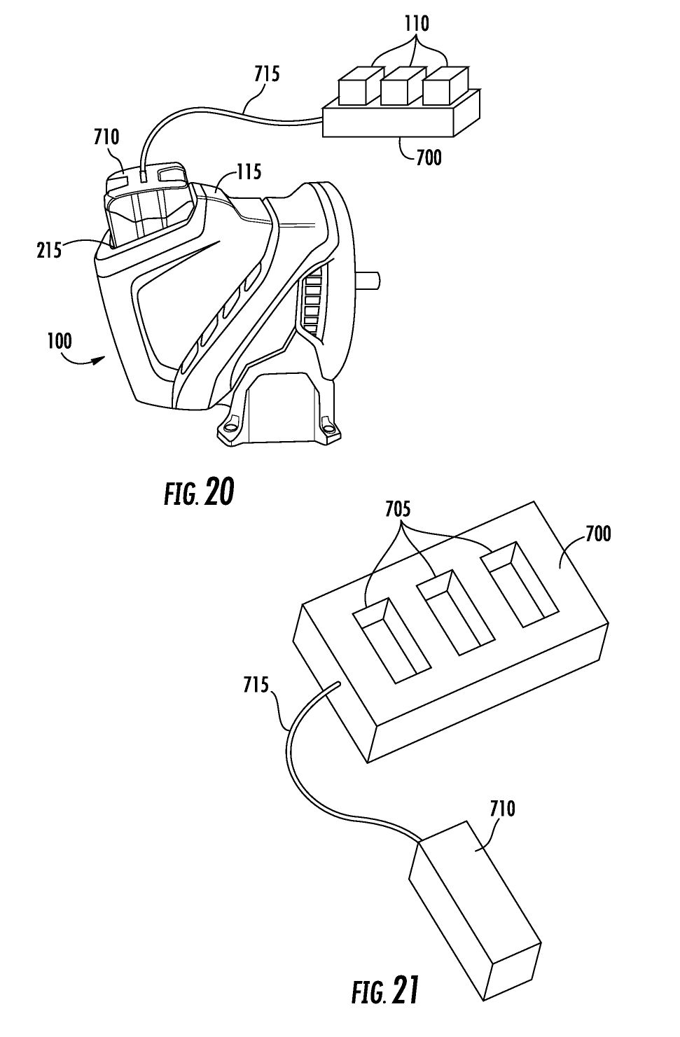

In some embodiments of the electric powerhead 100, more than one removable battery 110 is provided to increase the available electrical energy (e.g., to increase run time of the equipment). As shown in FIGS. 16-17, in some embodiments, the electric powerhead 100 includes multiple battery receptacles 215 in the housing 115. As shown in FIGS. 20-21, in other embodiments, an external battery tray 600 including multiple battery receptacles 605 is provided. The battery tray 600 includes a plug 610 that is configured to engage the battery receptacle 215 of the electric powerhead 100 in the same manner as a removable battery 110 to electrically couple the battery receptacles 605 of the battery tray 600 to the battery receptacle 215 of the electrical powerhead 100. The battery receptacles 605 of the tray are configured in the same manner as the battery receptacles 215 of the electric powerhead 100. Batteries 110 attached to the battery receptacles 605 of the battery tray 600 are therefore electrically coupled to the electric powerhead 100. The battery tray 600 may be attached to the equipment in a location remote from the electric powerhead 100. An electrical cord or harness 615 electrically connects the plug 610 to the battery receptacles 605. In some embodiments, the battery tray 600 includes one or more battery receptacles 605 that are configured to receive a different battery than the battery receptacle 215 of the electric powerhead 100. For example, the tray battery receptacle 605 may be configured to receive a battery having an increased capacity than the battery used with the electric powerhead 100. For example, the tray battery receptacle 605 may be configured to receive a high capacity battery (e.g., rated at 1 kilowatt hour) that has a different footprint that the battery 110 used with the electric powerhead 100 (e.g., rated between 150 and 500 watt hours).

In some embodiments, a run sensor 103 is included with the electric powerhead 100. The run sensor 103 is configured to detect when an implement on outdoor power equipment is in a ready-to-run condition. As such, the run sensor 103 is communicably and operatively coupled to the controller 250 and to remote user controls (e.g., user controls 340, 570). Depending on the type of outdoor power equipment with which the powerhead 100 is used, the run sensor 103 can take different forms. For example, the run sensor 103 may be a switch configured to detect the state (e.g., engaged or disengaged) of a brake or clutch (e.g., for a lawn mower), a switch configured to detect operator presence in the operating position (e.g., a seat switch on a tractor or a hand-actuated switch or bail on a handle), an enable fob or key configured to allow the electric motor 105 to start when actuated or present and prevent the electric motor 105 from starting when not actuated or present, a switch configured to sense water or another fluid (e.g., a capacitive water detection sensor, a pressure sensor, a flow sensor) to ensure that a pump has sufficient fluid to operate safely (e.g., for a pressure washer or waste pump).

For example, in a lawn mower (e.g., lawn mower 300 shown in FIG. 10) including a mower blade as the implement, the run sensor 103 detects when a brake that selectively prevents the blade from rotating is in a released position so that the blade is allowed to rotate. The mower blade is in the ready-to-run condition when the brake is released. In another example, in a pressure washer including a fluid pump as the implement, the run sensor 103 detects a threshold fluid flow through the fluid pump to a spray gun. The fluid pump is in the ready-to-run condition when the threshold fluid flow is detected (e.g., by flow rate, by flow volume, by fluid pressure, etc.) that is indicative of sufficient fluid supplied to the fluid pump to allow for operation of the fluid pump. In another example of a pressure washer including a fluid pump as the implement, the fluid pump is in the ready-to-run condition when the run sensor 103 detects the presence or actuation of an enable key or fob. In some embodiments, the outdoor power equipment and/or electric powerhead 100 includes more than one run sensor 103 and all the run sensors 103 must be satisfied before the implement is considered to be in the ready-to-run condition.

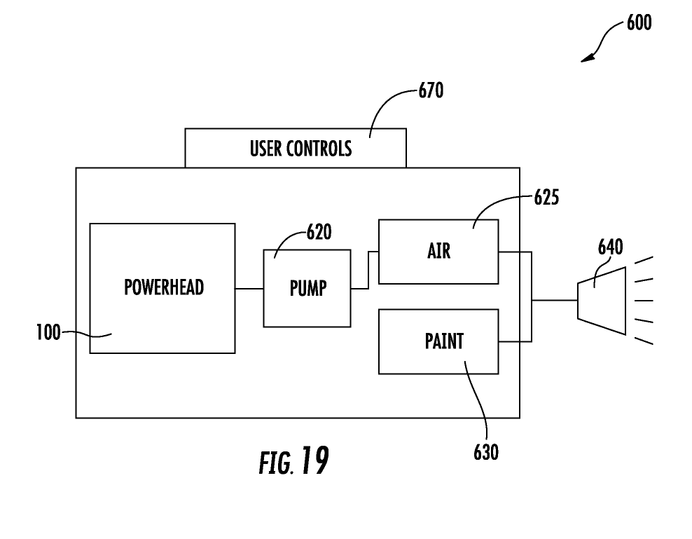

As another example, FIG. 19 shows a paint sprayer 600 powered by the powerhead 100 and including a pump 620, an air vessel 625, a paint vessel 630, a nozzle 640 and user controls 670. The powerhead 100 only runs when necessary to run the pump 620 to fill the air vessel 625 with pressurized air. A pressure sensor monitors the pressure of the air in the air vessel 625 and provides a run command signal to the powerhead 100 when the pressure drops below a threshold indicating the need to refill the air vessel 625. The ready-to-run command is provided by the user controls 670 when the user turns the paint sprayer 600 on. As another example, a log-splitter or post-hole auger may also be used with a ready-to-run command in connection with a hydraulic reservoir such that when a sensor detects the need to refill the hydraulic reservoir, the run command signal is provided to the powerhead 100.

The controller 250 is configured to receive inputs associated with the run sensor 103. The controller 250 receives a ready-to-run signal from the run sensor 103. The electric motor 105 starts when upon receiving a ready-to-run signal from the run sensor 103 and upon receiving an additional start signal from the user interface (e.g., user controls 340 or 570). Additional information or control logic may also be configured to start the engine in combination with the status of the run sensor 103 and/or other factors.

The Appendix included with the U.S. Provisional Application No. 62/413,802, filed on Oct. 27, 2016 and incorporated herein by reference in its entirety, describes and illustrates various aspects of electric powerheads and related outdoor power equipment.

The construction and arrangement of the apparatus, systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, some elements shown as integrally formed may be constructed from multiple parts or elements, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions and arrangement of the exemplary embodiments without departing from the scope of the present disclosure.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

Although the figures may show or the description may provide a specific order of method steps, the order of the steps may differ from what is depicted. Also two or more steps may be performed concurrently or with partial concurrence. Such variation will depend on various factors, including software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps

What is claimed is:

1. An electric powerhead, comprising:
a housing including a mounting plate, wherein the mounting plate includes a shaft opening, a plurality of first openings arranged in a standard vertical shaft engine mounting pattern and a plurality of second openings arranged in a standard horizontal shaft engine mounting pattern;
an electric motor positioned within the housing, wherein the electric motor includes an output shaft that extends through the shaft opening of the mounting plate and wherein the output shaft is configured to rotate about an axis of rotation; and
a support configured to be removably attached to the housing, wherein with the support attached to the housing, the output shaft is arranged horizontally.

2. The electric powerhead of claim 1, wherein the plurality of first openings comprises three openings.

3. The electric powerhead of claim 1, wherein the plurality of second openings comprises four openings.

4. The electric powerhead of claim 1, wherein the support includes a plurality of third openings arranged in a standard horizontal shaft engine supporting pattern.

5. The electric powerhead of claim 4, wherein the plurality of third openings comprises four openings.

6. The electric powerhead of claim 1, further comprising a power take off including a second coupling configured to removably attach to the first coupling of the output shaft.

7. The electric powerhead of claim 6, wherein the first coupling comprises an internal spline and the second coupling comprises an external spline.

8. The electric powerhead of claim 1, wherein with the support attached to the housing, a bottom surface of the support is spaced apart from the axis of rotation of the output shaft by a vertical distance equal to a standard horizontal shaft engine spacing.

9. An electric powerhead, comprising:
a housing including a mounting plate, wherein the mounting plate includes a shaft opening;
an electric motor positioned within the housing, wherein the electric motor includes an output shaft that extends through the shaft opening of the mounting plate and wherein the output shaft is configured to rotate about an axis of rotation; and
a support configured to be removably attached to the housing, wherein the support includes a plurality of openings arranged in a horizontal shaft supporting pattern.

10. The electric powerhead of claim 9, wherein the plurality of openings comprises four openings.

11. The electric powerhead of claim 9, wherein with the support attached to the housing, a bottom surface of the support is spaced apart from the axis of rotation of the output shaft by a vertical distance equal to a standard horizontal shaft engine spacing.

12. The electric powerhead of claim 9, further comprising a power take off including a second coupling configured to removably attach to the first coupling of the output shaft.

13. The electric powerhead of claim 12, wherein the first coupling comprises an internal spline and the second coupling comprises an external spline.

14. An electric powerhead, comprising:
a housing including a mounting plate and a battery receptacle, wherein the mounting plate includes a shaft opening;
an electric motor positioned within the housing, wherein the electric motor includes an output shaft that extends through the shaft opening of the mounting plate and wherein the output shaft is configured to rotate about a shaft axis of rotation; and
a battery configured to be removably attached to the battery receptacle to provide electricity to the electric motor;
wherein the battery receptacle is positioned so that a straight axis of insertion along which the battery is inserted into the receptacle is positioned at an angle relative to the shaft axis of rotation.

15. The electric powerhead of claim 14, wherein the battery receptacle includes a stop surface that is configured to contact a face of the battery when the battery is inserted into the receptacle; and
wherein the stop surface is positioned at an angle relative to the shaft axis of rotation.

16. The electric powerhead of claim 14, further comprising a battery receptacle housing rotatably attached to the housing about a housing axis of rotation, wherein the battery receptacle housing includes the battery receptacle.

17. The electric powerhead of claim 16, wherein the housing axis of rotation is positioned at an angle to the shaft axis of rotation.

18. The electric powerhead of claim 16, wherein the housing axis of rotation is parallel to the shaft axis of rotation.

19. The electric powerhead of claim 16, wherein the housing axis of rotation and the shaft axis of rotation are collinear.

20. The electric powerhead of claim 16, wherein the housing axis of rotation and the shaft axis of rotation are not collinear.
